(19) United States
(12) Patent Application Publication
(10) Pub. No.: US 2011/0145643 A1
(43) Pub. Date: Jun. 16, 2011

(54) REPRODUCIBLE TEST FRAMEWORK FOR RANDOMIZED STRESS TEST

(75) Inventors: Amit Kumar, Redmond, WA (US); Howard Sun, Mill Creek, WA (US); Andre Muezerie, Bellevue, WA (US)

(73) Assignee: Microsoft Corporation, Redmond, WA (US)

(21) Appl. No.: 12/634,713

(22) Filed: Dec. 10, 2009

(51) Int. Cl. G06F 11/00

(52) U.S. Cl. 714/33; 714/32; 714/E11.02

(57) ABSTRACT

A test framework architecture that separates the generation of random test actions from test execution and provides a way to record the state of the system under test at user controlled intervals. This saved state is used to bring the test system to the last known state before failure and then execute the much smaller set of actions to the point of failure, thus requiring shorter run time. Given the same time constraints, this enables the execution of this smaller set more frequently, providing better bug fix verification and shorter reproduction time.

### BACKGROUND

Oftentimes the discovery of bugs in distributed systems such as failover clusters require stress tests that perform actions on multiple systems or components, in a certain sequence or in parallel, with specific timing. To provide such test coverage, stress tests have been developed to perform random actions in serial or parallel for an extended period of time. Problems that arise from this approach include bug reproduction and fix verification, test coverage and maintenance, and test setup and cleanup.

With respect to bug reproduction and fix verification, reproduction of a specific issue or verification of a specific fix has proven to be very challenging due to the extended runtime of these tests. Even if such tests could execute the same test actions in the same sequence, it could take a lot of time to reach the point of failure, and even then, a failure reproduction is not guaranteed due to timing variances or non-deterministic decisions in the system under test itself. In such situations, one approach has been to run these extended tests multiple times to increase the certainty to reproduce the failure or to verify the fix.

With respect to test coverage and maintenance, stress tests become increasingly more complex and costly to maintain as new actions are added, due to the impact of the new actions on existing test actions caused by interactions between systems or components. Additionally, due to the random nature of actions, full coverage of all actions cannot be guaranteed without an extended run time. Standard tests that exercise limited components with limited randomization can reduce runtime and broaden coverage, but miss important interactions between system components and expose fewer bugs than if different types of actions were taken concurrently and randomly. As a result, two sets of tests must be run—one for functional coverage and one for stress.

With respect to test setup and cleanup, tests often leave the system under test in a state different than that of the system originally before the test run—while also requiring the system to be in a “clean” state before the test starts. This prevents tests from being run on systems with different initial conditions that may simulate specific user scenarios, and also require dedicated cleanup before or after the test is run. Existing test frameworks sacrifice the ability to repeat an exact scenario and limit the amount of randomization supported by the test.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a test framework that separates the generation of random test actions from test execution and provides a way to record the state of the system under test at user controlled intervals. This saved state is used to bring the test system to the last known state before failure and then execute the much smaller set of actions from the restore point to the point of failure without requiring the rest of the test to be run, thus requiring shorter run time. Given the same time constraints, this enables the execution of this smaller set more frequently, providing better bug fix verification and shorter reproduction time.

Accordingly, the test framework architecture includes logic that takes a random test as an input, and generates a deterministic test for execution separately. Additionally, functionality is provided that periodically saves the state of the test system and brings the same or different system to the last known state for quicker bug reproduction and fix verification. The saved system state is utilized with a test model to allow tests to adapt to any system state, as well as restoring system state after test.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented test system in accordance with the disclosed architecture.

FIG. 2 illustrates an alternative embodiment of a test system.

FIG. 3 illustrates an exemplary script generator and execution system for testing a system under test.

FIG. 4 illustrates a client-based test execution system.

FIG. 5 illustrates a flow diagram for the life of a thread.

FIG. 6 illustrates a computer-implemented test method in accordance with the disclosed architecture.

FIG. 7 illustrates additional aspects of the method of FIG. 6.

FIG. 8 illustrates additional aspects of the method of FIG. 6.

FIG. 9 illustrates a block diagram of a computing system operable to execute reproducible and random testing in accordance with the disclosed architecture.

### DETAILED DESCRIPTION

The disclosed reproducible-randomization architecture separates the generation of random test actions from test execution, and provides a way to record the state of the system under test (SUT) at user controlled intervals. The test framework generates and performs random test actions and verifications, given a user-defined template that specifies basic parameters of randomization, and saves every action being performed—as well as system state snapshots, so that all or parts of the same test can be executed deterministically later.

The reproducible-random framework addresses the need of a multi-threaded and randomized stress test that can easily repeat the same test actions in the same sequence from a previous test run. While the framework provides randomization, the framework also encodes the order of actions and random decision results into the test script, which can be executed multiple times deterministically.

As a result, a first step generates the test command script that contains the deterministic test actions and verifications. This is generated based on test cases and scenarios provided by the user in a high-level template file (which can be a script), which also specifies the randomizations desired. A second step actually runs the tests from the test command script, which is equivalent to looking at the test log of a test run and attempting to repeat the exact same actions in the same sequence.

The test framework architecture is modular in that developers can implement custom code as test actions and verification commands in a custom module, compiled into an executable file (e.g., DLL-dynamic link library). One or more test executable files can be loaded by the framework. As a result, the framework supports commands that target different components, features, and even products on the SUT, and can be expanded. This can be accomplished by users or developers adding binaries separate from the framework.

The framework is adaptive, in that the SUT can be queried to obtain (be aware of) existing state before starting the test, and periodically during the test (as “snapshots”). The test uses the existing state to build a test model for utilization in test action and verification. By utilizing model-based testing, this pushes test verification logic into the test model, which can be reused by any action or test, even those not using the disclosed reproducible-random framework. This also allows tests to be run under a wide variety of initial conditions, as well as bringing the initial state of the SUT to a specific condition to reproduce a test case or scenario.

The test framework is scriptable. While the framework supports randomization, the final test execution follows a non-random test script that can be repeated later to better reproduce an exact scenario. The test script can be generated based on a user-provided template script, and invokes both test actions and appropriate verification based on the expected system states from the test model. In addition, the framework can snapshot SUT state to a script or data file, as well as restore and verify SUT state based on a script or data file, allowing a script to be executed from a mid-point when given snapshot logging information from a previous test run.

The framework is highly parallel. The test script supports dependency expressions between test commands, and test execution performs the commands in such a way to attain the maximum parallelism allowed by the dependency expressions. Test actions can be configured to be parallel by default, for example, unless the user specifies sequential. This allows a test to easily attain the maximum degree of parallelism.

When a test runs a set of actions sequentially, unless the test developer specifically creates multiple threads and either writes separate code for different threads or runs the same code in multiple threads, the developer has to ensure each thread does not perform conflicting actions, or put everything in work items. All are tedious.

The disclosed execution engine runs the actions from an input command script, in parallel, unless there are specific dependencies between commands, in which case, the commands are run in sequential order based on the dependencies. In this model, the user or generator creating the script knows which actions are to be performed serially. If the script has a set of actions that do not have dependencies, the execution engine will automatically create as many threads as needed to dynamically execute the actions in parallel.

This changes the test mindset from “assume everything runs serially unless parallelism is specified and implemented” to “assume everything runs in parallel unless a set of actions are serialized”. The former requires more work to attain parallelism, while the latter requires more work to ensure serialization. In today's world of multiple processing cores on a single system, multiple actors on a system (e.g., users, processes, clients, etc.), and distributed systems, the parallelism is more useful.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

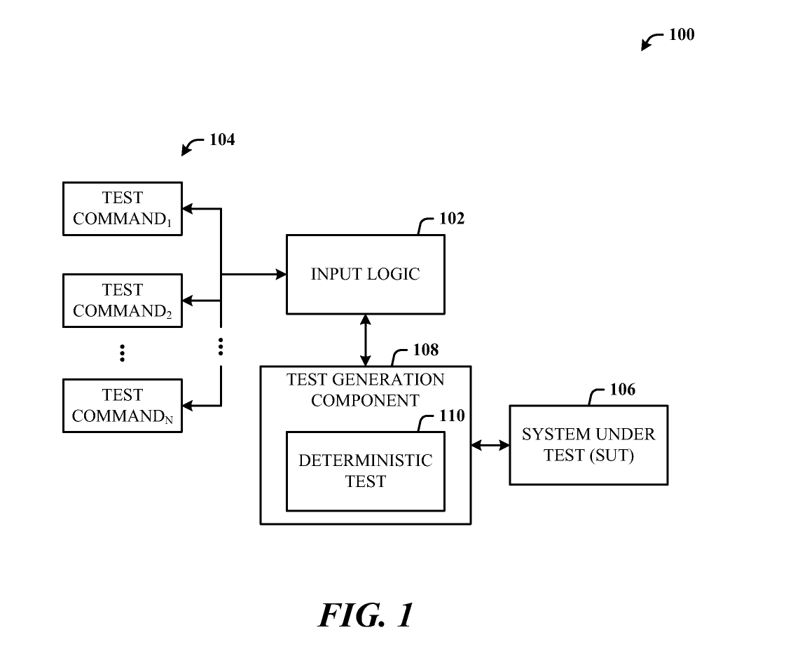

FIG. 1 illustrates a computer-implemented test system 100 in accordance with the disclosed architecture. The test system 100 includes input logic 102 that receives test commands 104 for testing a system under test (SUT) 106. The system 100 can also include a test generation component 108 for generating a deterministic test 110 for execution against the SUT 106. The deterministic test 110 is based on the test commands 104 and is executed separately from the test commands 104. The input logic 102 further receives execution order, randomization information, and parallelism information related to the test commands 104.

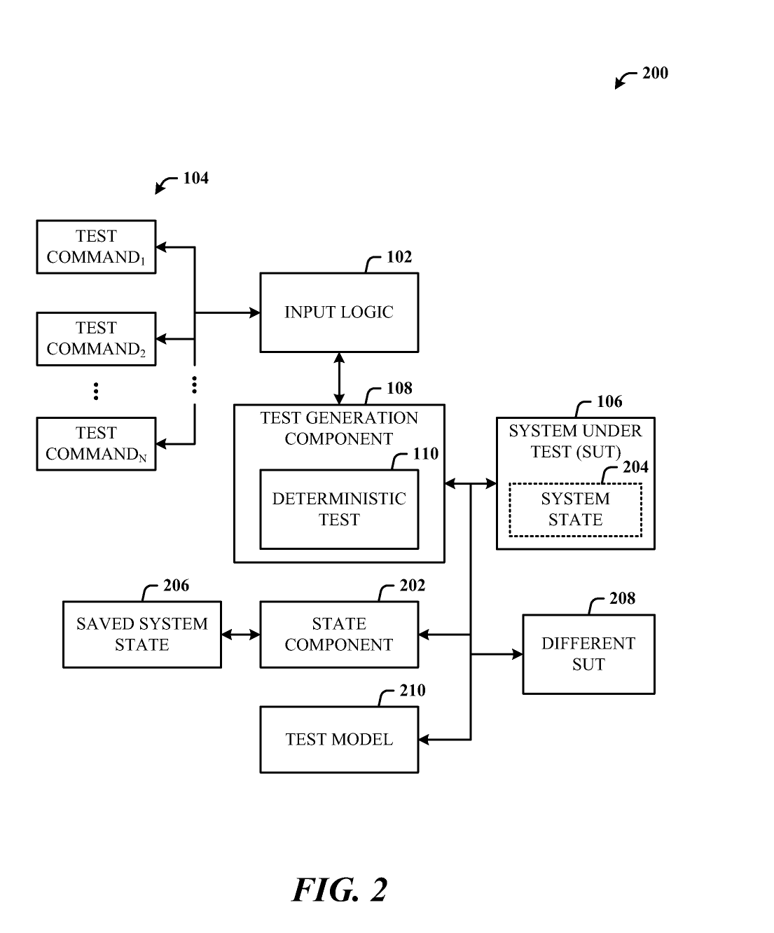

FIG. 2 illustrates an alternative embodiment of a test system 200. The system 200 includes the entities and components of the system 100 of FIG. 1. The system 200 can further comprise a state component 202 that periodically saves system state 204 of the SUT 106, represented as saved system state 206. The saved system state 206 is used to bring the SUT 106 to a prior known state, if desired. The saved system state 206 obtained from the SUT 106 can be used to bring a different SUT 208 to the prior known state that is derived from the SUT 106. The saved system state 206 can be used with a test model 210 to enable tests to be adapted to other system state. The test model 210 can be developed from existing system state and snapshots of the system state obtained as part of testing the SUT 106.

The system 200 can further comprise other entities (not shown, but described herein below) such as a template that specifies parameters of randomization for random test actions and verifications, and a test script generated from the template that invokes test actions and verification based on expected states from a test model. The test script enables querying of the system state 204, restoration of the system state 204, and verification of system state 204 of the SUT 106.

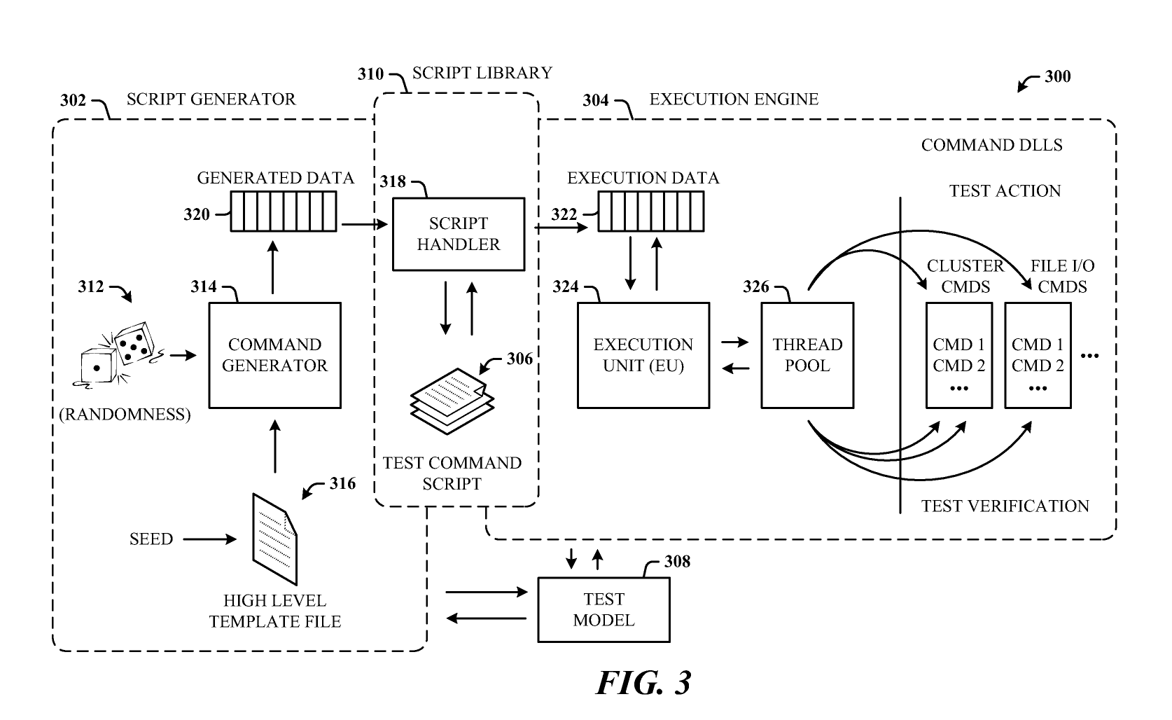

FIG. 3 illustrates an exemplary script generator and execution system 300 for testing a system under test. A script generator 302 takes a template file (also referred to as a template script) as input, performs randomization and test model logic, and then determines the actual test commands to be executed.

The following definitions will be used in describing the architecture. An SUT can be a cluster, another distributed system, or a single system. A template file is a script (e.g., created by an end-user) used as input to a command script generator. The template file serves as a template on which the actual test script will be generated. The template file can include randomization and variables which will be processed by the command script generator in order to generate a deterministic test script.

A test action is a test command to be performed on the SUT as part of a test case or scenario. A test command is a specific set of tasks (e.g., API calls, running other scripts, tests, tools, etc.) to be performed. This is the minimal unit of execution in the reproducible-random test framework. Test verification is a test command to be performed on the SUT to verify a previous action. A test execution engine 304 is the component which takes a test command script 306 and performs the commands in the script 306 in the specified dependency order.

The test execution process involves many components. From end-to-end, the test logic flows in the following order. A user creates a script template (the template file), specifying a list of test commands to be executed, as well as a desired order, parallelism, and randomization. Generally, the script generator 302 reads the template script, processes the test logic of the template script and, generates test actions and verifications based on the template script, and optionally, a test model 308. Both actions and verifications are written as commands to a deterministic test script. Command dependencies determine execution order and concurrency, which are run by the execution engine 304. Both the script generator 302 and execution engine 304 use a script library 310 to write and read the test command script 306.

More specifically, randomness 312 is introduced through a pool of tests that are available for input to a command generator 314. The command generator 314 accepts a high-level template file 316 as input as well, which contains the instructions to be used to create the test command script 306 in a high-level language.

An output of the script generator 302 is a text file that includes the commands to be invoked by an execution unit. The test command script 306 can be created via a script handler 318 (e.g., reader, writer, parser, tokenizer, etc.) using data 320 generated from the command generator 314. The script generator and execution system 300 also implements randomization and the test model 308 (e.g., for clusters) to exercise the tests summarized in the template file 316.

The script handler 318 generates an execution data structure 322 that includes data read from the script 306 as well as data for test execution. A test execution unit 324 interacts with the data structure 322. The test execution unit 324 reads the generated test script 306, and performs commands in the script 306. A command dependency expression determines which command is executed before/after another command, and whether in an existing or new thread. When a command is performed, the code in the command executable (e.g., DLL) is executed to perform the actual test action/verification.

The template file 316 can be created by the user, and used by the command generator 314 to create the actual test command script 306 used by the execution engine 304. The script of the template file 316 supports basic functionalities of the command script 306 (e.g., all the commands and dependencies), plus additional commands and parameters to allow randomization, command grouping, variables, and looping.

The template file 316 input to the command generator 314 can be in a markup language format (e.g., XML-extensible markup language). Users do not need to specify DLLs in the commands, as all loaded DLLs register supported command names (command names have a global namespace). The command generator 314 can determine the DLL in which the command is implemented. The execution unit 324 assigns tasks according to threads available in a thread pool 326.

Following is an example of a test template file in XML.

<TestTemplate>

<Set var=“$NodeList”>

<GetNodes nodes=“allnodes” />

</Set>
<Group numthreads=“4” numcommands=“4”>

<Group numthreads=“1” numcommands=“10” desc=“Add Evict

operations for N1”>

<WaitSeconds count=“10” desc=“Wait”/>
<EvictNode node=“C5C1F4X64N1” desc=“Evicting node

N1”/>

<AddNode node=“C5C1F4X64N1” desc=“Adding node
N1”/>

</Group>
<Group numthreads=“1” numcommands=“10” desc=“Add Evict

operations for N2”>

<WaitSeconds count=“12” desc=“Wait”/>
<EvictNode node=“C5C1F4X64N2” desc=“Evicting node

N2”/>

<AddNode node=“C5C1F4X64N2” desc=“Adding node
N2”/>

</Group>
<Group numthreads=“1” numcommands=“50” desc=“Pause

Resume related operations for N3” exeorder=“random”>

<WaitSeconds count=“2” desc=“wait”/>
<PauseNode node=“C5C1F4X64N3” desc=“Pausing node
N3”/>
<WaitSeconds count=“3” desc=“Wait”/>
<ResumeNode node=“C5C1F4X64N3” desc=“ Resuming

node N3”/>

</Group>
<Group numthreads=“1” numcommands=“50” desc=“Pause

Resume related operations for N4” exeorder=“random”>

<WaitSeconds count=“4” desc=“wait”/>
<PauseNode node=“C5C1F4X64N4” desc=“Pausing node
N4”/>
<WaitSeconds count=“5” desc=“Wait”/>
<ResumeNode node=“C5C1F4X64N4” desc=“Resuming

node N4”/>

<PauseNode node=“C5C1F4X64N4” desc=“Pausing node
N4”/>
<ResumeNode node=“C5C1F4X64N4” desc=“Resuming

node N4”/>

</Group>

</Group>

</TestTemplate>

All script handling (e.g., read, write, parsing, tokenizing, etc.) can be performed in a script processing library, to allow script changes or to support different script formats. The script library serves as a converter between internal data structures in the command script generator 304 and test execution unit 316.

User DLLs can include a cluster DLL, miscellaneous DLL, and File I/O DLL. The framework loads one or more of the DLLS and learns about action names and action parameters from the loaded DLLs. Tokens can be used to process data faster and use less memory. From an action token, it is possible to determine which DLL implements it. For example, tokens 1-60 can be mapped to the cluster DLL, tokens 61-70 can be mapped to the miscellaneous DLL, and tokens 71-80 can be mapped to the File I/O DLL.

In order to facilitate the implementation of the command randomization, an internal matrix may be built which is populated appropriately before the output file is generated. The columns can represent the threads and the rows can represent the commands to execute. By doing this, commands with an option “AtLeastOnce” may be used first to populate the matrix. Since the matrix will be empty/almost empty at this point, good randomization can be used to choose the thread/command position for these. The remaining empty elements can be filled using other designated priorities levels.

The test command script 306 provides for parallel execution and deterministic ordering through dependency expressions: every command in the script 306 depends on another (except for commands that execute immediately on test start). A command that depends on another—either directly or indirectly—will be executed afterwards. A command that does not have any dependency relationship to another can be executed in parallel, before, or after. Multiple dependencies and dependents are allowed per resource. With multiple dependencies, a command can require all previous commands to complete first (“and” dependency), or just one command to complete (“or” dependency).

Following is an example of a test command script.

# Node Alias Declaration
SetNodeName -Tag 1 -Node N1,N2,N3,N4 -Name

c5c1f4x64n1,c5c1f4x64n2,c5c1f4x64n3,c5c1f4x64n4

# Add Evict operations for N1
# Wait
WaitSeconds -Tag 2 -Count 10 -Dep 1
# Evicting node N1
EvictNode -Tag 3 -Node N1 -Dep 2
# Adding node N1
AddNode -Tag 4 -Node N1 -Dep 3
# Wait
WaitSeconds -Tag 5 -Count 10 -Dep 4
...
# Evicting node N1
EvictNode -Tag 9 -Node N1 -Dep 8
# Adding node N1
AddNode -Tag 10 -Node N1 -Dep 9
# Wait
WaitSeconds -Tag 11 -Count 10 -Dep 10
# Add Evict operations for N1
# Wait
WaitSeconds -Tag 122 -Count 10 -Dep 11
# Evicting node N1
EvictNode -Tag 123 -Node N1 -Dep 122

In one implementation, the test command script 306 does not use XML. However, where the command generator 314 and the script handler 318 are designed to support XML, the test command script 306 can be specified in XML as well.

Note that in one implementation, the test model for validation can be in the command generator 314—not in the execution unit 324. While the lack of a test model could prevent the test execution unit 324 from dynamically adapting to non-deterministic behavior in the SUT, it could simplify the test action commands and verification commands, and make execution more deterministic. However, the test execution unit 324 would still need to deal with non-deterministic behavior in the SUT. To do this, the command generator 314 generates verification commands that tolerate a number of possible states, if such ambiguity does not affect test execution going forward; if such ambiguity must be resolved, such commands will be generated to bring the SUT to a deterministic state. In another implementation, the test model 308 for validation is in the execution engine 304, allowing the system 300 to adapt to the SUT being in various states, with the same commands being executed, but with the actual outcome determined by the state of the SUT. If the actual outcome does not match that expected by the test model 308, the test will fail. When encountering ambiguities caused by non-deterministic behavior in the SUT, this implementation can update the test model 308 based on the actual outcome.

In another implementation, timing of test execution is not deterministic. While the general order of command execution can be enforced, the exact timing of command execution would not be guaranteed, especially between parallel threads. When any test performs commands that may affect each other in parallel, the timing and outcome is not deterministic. This can cause the outcome to differ between individual test runs.

Using a cluster example, consider that a test moves a group to a node. If the test performs thorough verification, it would normally ensure that the group moves to and comes online. Now restart the target node at the same time. This depends on the order that the calls went through—the group move call may fail in the first place; even if it is moved before cluster service shuts down, the group may or may not come online, depending on the time it takes to bring the group online on the node.

In the above example, the verification code allows multiple possible results based on the timing of the execution. If no test model 308 is used with the execution engine 304, the test or user needs to be aware of this during script generation and create the proper verification commands.

The disclosed framework can support the following types of tests:
Tests that cover basic individual functionality (e.g., calling individual cluster APIs and result validation)
Tests that target a specific feature or scenario in one or more components (e.g., calling a series of related cluster APIs and result validation in a specific customer scenario)
End-to-end tests that replicate user actions across multiple customer scenarios or use cases, in order to accomplish a user goal (e.g., calling a series of cluster APIs to setup a cluster, setup appropriate roles, and perform tests and validation on the role's features)
Stress tests that are complex and extended tests that perform multiple random actions, on multiple components in parallel
Negative tests that perform unsupported or invalid actions or input, and validate errors returned by the SUT
Tests that generate random data inputs to the SUT.

For users, the framework provides the following:
Ease of test setup and execution: given an existing test and concise instructions, a user can easily setup the test on a new system and execute tests
Result triaging and analysis: tests generate complete and concise logs, showing sufficient details to quickly triage failures
Extensibility: users can develop and add new test commands to the framework

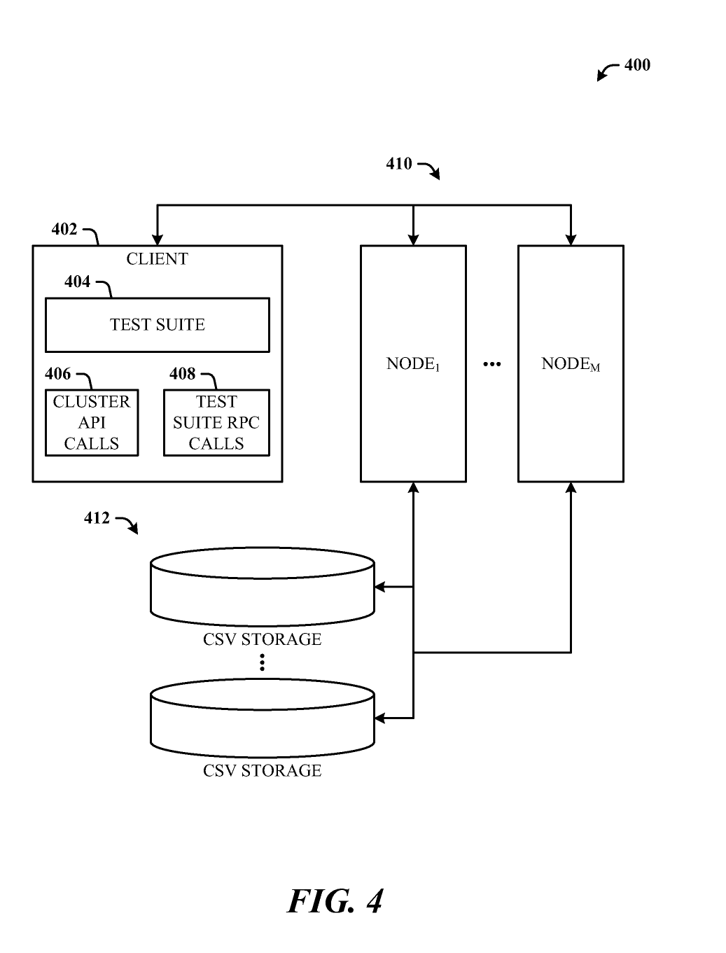

FIG. 4 illustrates a client-based test execution system 400. For failover cluster and cluster shared volume (CSV) tests, the test can be run on a client machine 402. The test suite 404 comprises all the entities and components of FIG. 1, FIG. 2, or FIG. 3. The test commands from the test suite 404 make calls from a cluster API 406 and test suite RPC calls 408, targeting cluster nodes 410 in the SUT (which here, is a cluster and associated CSV storage 412). The cluster API calls 406 perform cluster actions and verifications, while the test RPC calls 408 call into test services running on the cluster nodes 410. The test services perform node crashing or starting/stopping cluster service on nodes, file system calls and file I/O actions targeting CSV storage 412, and executing other tests or tools that perform failure service calls or file I/O actions on CSV storage 412.

The syntax can include a Set tag that allows for variable definition, a Group tag that allows for the grouping of actions (e.g., Group1 is for adding and evicting node N1, Group2 is for pausing and resuming node N2, etc.), and a ForEach tag that enables looping of a group of actions. Additional actions are described infra.

The API calls are to support test commands implemented within the framework. Both the command script generator 304 and the test execution unit 316 call into these test commands to perform actual test logic. Cluster node actions can include node crash, node stop/start, node add/evict, and node pause/resume, for example. Cluster notifications can include wait for resource state or owner group/node change, wait for group state or owner node change, and wait for node state change, for example. CSV/storage commands can include create partition, delete partition, create volume, set volume drive letter, add CSV disk, remove CSV disk, and move CSV disk, for example.

Other cluster actions can include group actions, resource actions (including dependency expressions and resource type-specific actions), cluster network/net interface actions, checkpointing (e.g., registry/crypto), possible/preferred owners, anti-affinity, and failback, and cluster APIs.

These actions can be prevented from being executed if these actions could affect concurrent I/O whose timing is not controlled. For example, if an I/O is running that writes a specific number of bytes, even if its status is checked before performing another action affecting it, the I/O could complete before the action, making the result non-deterministic. Alternatively, concurrent actions can be allowed with I/O threads the actions could affect, by guaranteeing the expected result based on the expected I/O execution time or I/O controlled by events.

The script command generator 314 generates the appropriate verification commands based on the test (cluster) model 308. Some verification may involve the use of regular test action commands. The cluster model implements a simplified model of the cluster, which is used by the generator to create the test command script 306. This model 308 allows the generator to predict the expected outcome for each command in the output file generated.

The script handler 318 used by both the command generator 314 and test execution engine 304 takes the data 320 generated by the generator 314, and writes it to a file in a given file format. The script handler 318 is able retrieve the information back from a previously saved file.

A separate component used only when reading scripts is a script validation library, which is independent from the actual script format and syntax. This is performed after the script handler 318 validates the script syntax and reads the script into usable data structures (the structure 322), but before the data is used by other components, to ensure valid commands are specified.

The test execution unit 324 coordinates all the actions specified in the test command script by, for example, ensuring that all ordering and dependencies between commands are met and initiates the actions at the right moment.

The test execution engine 304 takes snapshots of the entire SUT on command. The command script generator generates such commands between specified intervals (measured in number of commands) in the script. When performing a snapshot command, the execution engine queries the SUT state and dumps the snapshot in its logs, which can be used to re-run a specific test command script from a mid-point (test point during the test).

The thread management library creates the thread pool 326 containing a large, but fixed, number of threads, which are used during test execution to perform the work required for each command. A characteristic of this thread pool 326 is its low latency to initiate each action, which is useful for exploring possible timing issues in the cluster code.

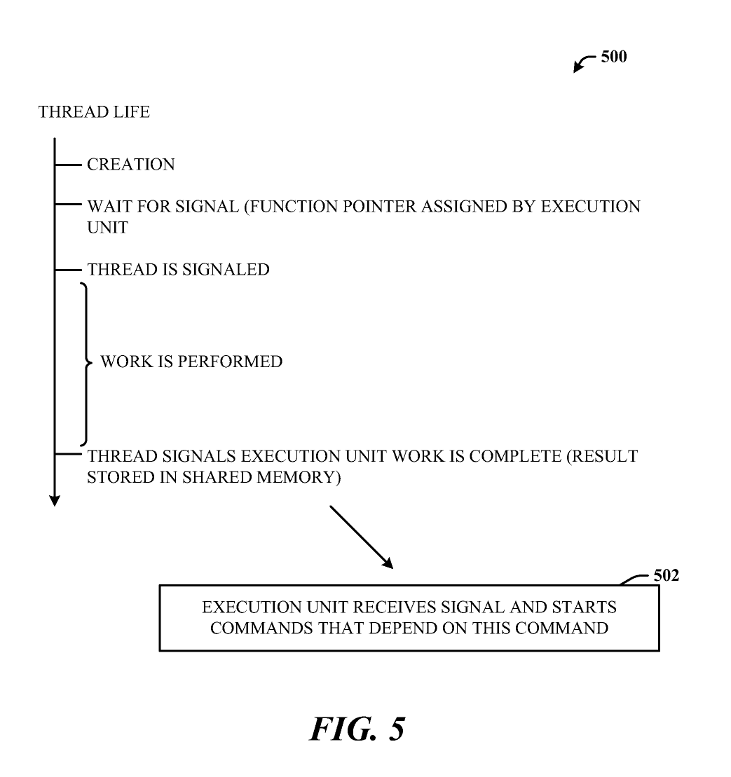

FIG. 5 illustrates a flow diagram 500 for the life of a thread. The thread pool 326 is populated when the execution unit 324 initializes. Each thread is created and waits for its own signal so that the test execution unit 324 can make each thread start working at the right moment. When the thread is signaled, the associated work is performed. This avoids any additional delays incurred by thread creation. When the thread finishes the work, the thread signals the test execution unit to indicate that the action was completed. The result of the work can be stored in shared memory. At 502, the execution unit receives the signal and starts commands that depend on this command.

Remote file I/O commands are the basic file system API calls and other file I/O actions and verifications. File system and I/O actions can include create empty file, create directory, create and write data, read file, write to existing file, seek/write/read, hold file open, copy file, delete file, remove directory, and lower priority (running third-party file system tests to perform I/O actions). Corresponding verifications can be determined at script generation time.

Variables affecting each action can include the following: different file sizes, different file paths within a CSV disk, flags for a CreateFile( ) API, whether actions target the same files, whether I/O action is performed on a local or a remote node, wait time before actions, and amount of time to perform the action.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

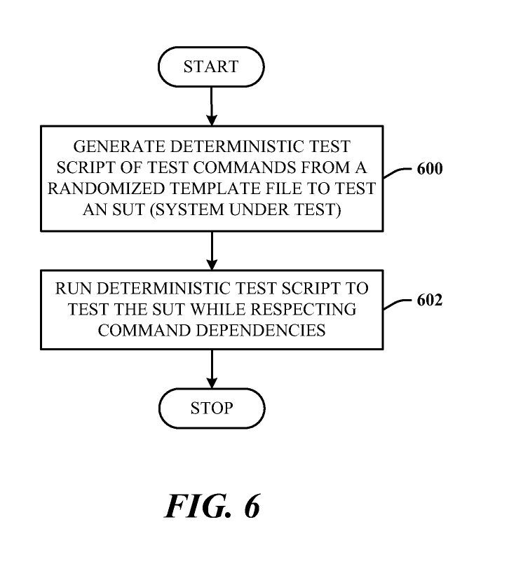

FIG. 6 illustrates a computer-implemented test method in accordance with the disclosed architecture. At 600, a deterministic test script of test commands is generated from a randomized template file to test an SUT. At 602, the deterministic test script is run to test the SUT while respecting command dependencies.

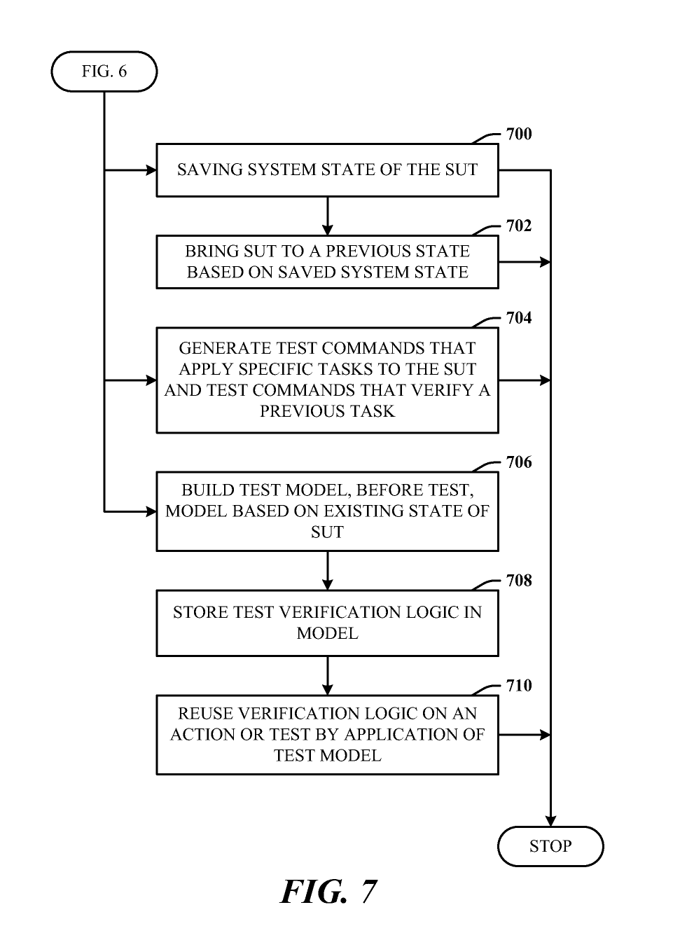

FIG. 7 illustrates additional aspects of the method of FIG. 6. At 700, system state of the SUT is saved. At 702, the SUT is brought to a previous state based on the saved system state. At 704, test commands are generated that apply specific tasks to the SUT and test commands that verify a previous task. At 706, a test model is built, before the test, where the model based on existing state of the SUT. At 708, test verification logic is stored in the model. At 710, the verification logic is reuse on an action or test by application of the test model.

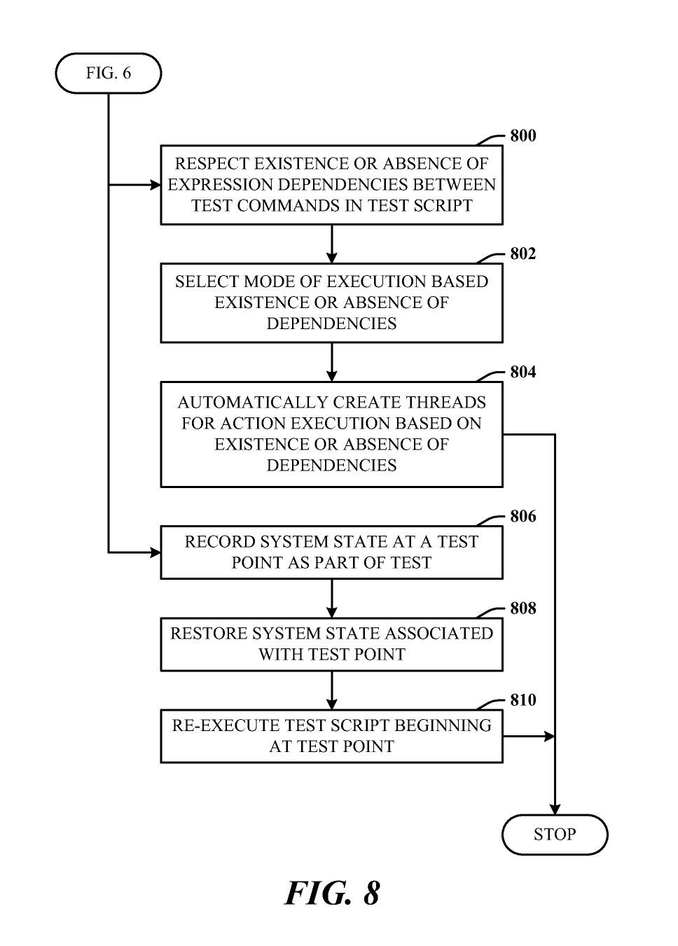

FIG. 8 illustrates additional aspects of the method of FIG. 6. At 800, existence or absence of expression dependencies between test commands is respected in the test script. At 802, a mode of execution is selected based the existence or absence of the dependencies. At 804, threads for action execution are automatically created based on the existence or absence of the dependencies. At 806, system state at a test point is recorded as part of the test. At 808, system state associated with the test point is restored. At 810, the test script is re-executed beginning at the test point.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

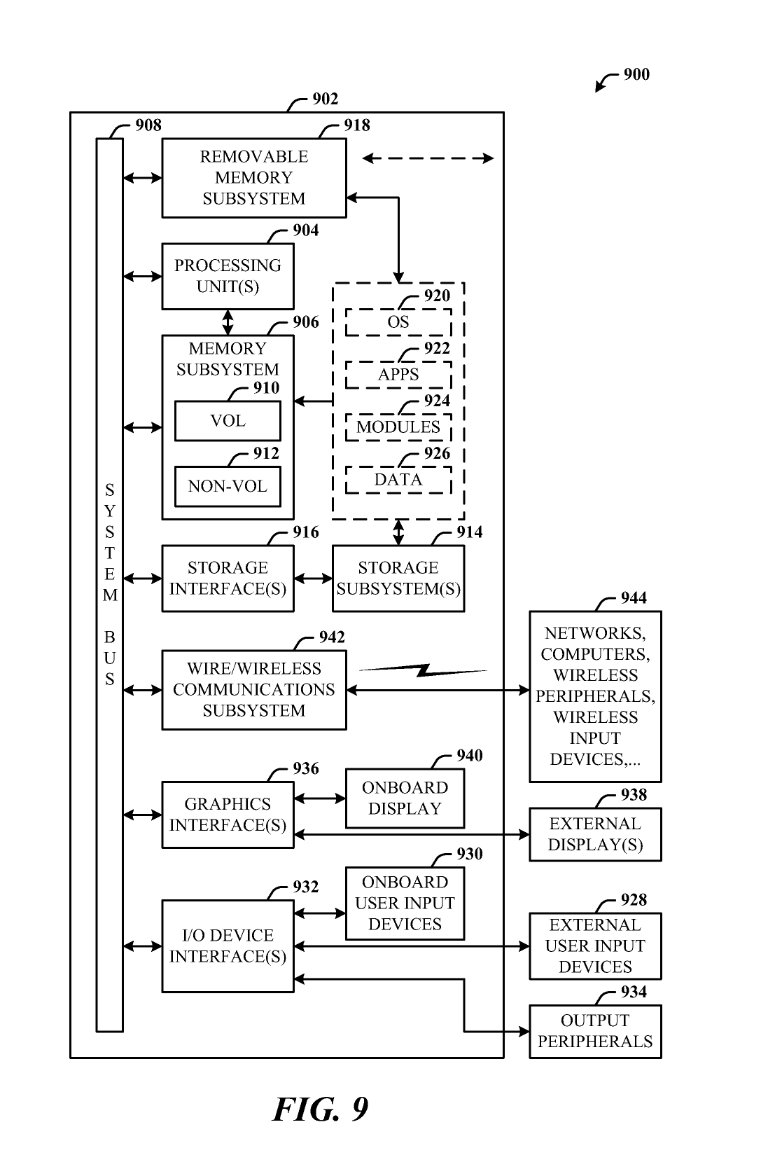

Referring now to FIG. 9, there is illustrated a block diagram of a computing system 900 operable to execute reproducible and random testing in accordance with the disclosed architecture. In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a computer-readable storage such as a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include computer-readable storage such as a volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components. The storage subsystem(s) 914 can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The one or more application programs 922, other program modules 924, and program data 926 can include the entities and component(s) of the system 100 of FIG. 1, the entities and component(s) of the system 200 of FIG. 2, the entities and component(s) of the system 300 of FIG. 3, the entities and component(s) of the system 400 of FIG. 4, the diagram 500 of FIG. 5, and the methods represented by the flow charts of FIGS. 6-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Computer readable media can be any available media that can be accessed by the computer 902 and includes volatile and non-volatile internal and/or external media that is removable or non-removable. For the computer 902, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

As previously described, the illustrated aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented test system, comprising:
input logic that receives test commands for testing a system under test (SUT); and
a test generation component for generating a deterministic test for execution against the SUT, the deterministic test based on the test commands and executed separately from the test commands.

2. The system of claim 1, wherein the input logic further receives execution order, randomization information, and parallelism information related to the test commands.

3. The system of claim 1, further comprising a state component that periodically saves system state of the SUT.

4. The system of claim 3, wherein the saved system state is used to bring the SUT to a prior known state.

5. The system of claim 3, wherein the saved system state obtained from the SUT is used to bring a different SUT to the prior known state derived from the SUT.

6. The system of claim 3, wherein the saved system state is used with a test model to enable tests to adapt to other system state.

7. The system of claim 1, further comprising a test model developed from existing system state and snapshots of the system state obtained by an execution unit during test of the SUT.

8. The system of claim 1, further comprising a template that specifies parameters of randomization for random test actions and verifications.

9. The system of claim 8, further comprising a test script generated from the template that invokes test actions and verification based on expected states from a test model.

10. The system of claim 9, wherein the test script enables querying of the system state, restoration of the system state, and verification of system state of the SUT.

11. A computer-implemented test system, comprising:
a template component for creating a template file of randomized test logic;
a script generator that processes the randomized test logic into a deterministic test script; and
a test execution component that executes test commands of the deterministic test script on the SUT.

12. The system of claim 11, further comprising a test model developed from existing system state and snapshots of system state obtained as part of testing the SUT, the test model applied optionally as part of the testing the SUT.

13. The system of claim 11, wherein the test logic includes test action commands and test verification commands packaged in executable file.

14. The system of claim 11, further comprising a state component that at least one of periodically saves system state of the system under test, uses the saved system state to bring the SUT to a prior known state, or brings a different SUT to a prior known state derived from the SUT.

15. A computer-implemented test method, comprising:
generating a deterministic test script of test commands from a randomized template file to test an SUT; and
running the deterministic test script to test the SUT while respecting command dependencies.

16. The method of claim 15, further comprising
saving system state of the SUT; and
bringing the SUT to a previous state based on the saved system state.

17. The method of claim 15, further comprising generating test commands that apply specific tasks to the SUT and test commands that verify a previous task.

18. The method of claim 15, further comprising:
building a test model, before the test, the model based on existing state of the SUT;
storing test verification logic in the model; and
reusing the verification logic on an action or test by application of the test model.

19. The method of claim 15, further comprising:
respecting existence or absence of expression dependencies between test commands in the test script;
selecting a mode of execution based the existence or absence of the dependencies; and
automatically creating threads for action execution based on the existence or absence of the dependencies.

20. The method of claim 15, further comprising:
recording system state at a test point as part of the test;
restoring system state associated with the test point; and
re-executing the test script beginning at the test point.
